(19) United States
(12) Patent Application Publication
(10) Pub. No.: US 2011/0048126 A1
(43) Pub. Date: Mar. 3, 2011

(54) ARRANGEMENT FOR FILL-LEVEL MEASUREMENT

(76) Inventors: Sebastian ADLER, Dortmund (DE); Dirk Bleicker, Hemer (DE)

(21) Appl. No.: 12/862,534

(22) Filed: Aug. 24, 2010

(30) Foreign Application Priority Data
Aug. 27, 2009 (DE) 10 2009 038 744.7

(51) Int. Cl. G01F 23/24

(52) U.S. Cl. 73/304 R

(57) ABSTRACT

The invention relates to an arrangement for fill-level measurement of an electrically conductive liquid in a container, in particular for fill-level measurement in a reducing agent tank of an exhaust gas aftertreatment system, whereby a large number of electrodes (3, 4) are arranged some distance apart above one another in the vertical direction (2), so that the filling level can be derived from a change in the electrical potential difference between the two electrodes (3, 4) that results from the bridging of the distance between two electrodes (3, 4) with a conductive liquid, whereby the electrodes (3, 4) are connected to terminals by strip conductors (7, 8), whereby the electrodes (3, 4) and the strip conductors (7, 8) are embedded in a flexible carrier medium (1), and the strip conductors (7, 8) are elastic and crushable.

The invention relates to an arrangement for fill-level measurement of an electrically conductive liquid in a container, in particular for fill-level measurement in a reducing agent tank of an exhaust gas aftertreatment system, whereby a large number of electrodes are arranged some distance apart above one another in the vertical direction, so that the filling level can be derived from a change in the electrical potential difference between the two electrodes that results from the bridging of the distance between two electrodes with a conductive liquid, whereby the electrodes are connected to terminals by strip conductors.

Such arrangements for fill-level measurement are known. In particular, such arrangements are used in the monitoring of the filling level in the reducing agent tank of an exhaust gas aftertreatment unit. In this case, by means of selective catalytic reduction (English: Selective Catalytic Reduction, abbreviated SCR), a reducing agent is injected into the exhaust gas stream by means of a metering system, whereby a urea solution is usually used as a reducing agent. In the case of motor vehicles, this urea solution is entrained in a reducing agent tank, from which the reducing agent solution is removed, if necessary, by means of the metering system and is sprayed into the exhaust gas stream. Along these lines, reducing agent or urea solution is defined as both ammonia, or an ammonia solution, and a urea solution, and in particular a urea solution according to DIN 70070, the so-called AdBlue.

The selective catalytic reduction (abbreviated SCR-English: Selective Catalytic Reduction) refers to the technique of the reduction of nitrogen oxides in exhaust gases of diesel engines of utility vehicles, but also of other combustion systems, garbage incinerators, gas turbines, and industrial plants. The chemical reaction on the SCR catalyst is selective, i.e., the nitrogen oxides NOx are preferably reduced, while undesirable reactions are suppressed to a great extent. To run the reaction, ammonia is required, which is mixed in with the exhaust gas. This ammonia is metered into the exhaust gas stream in the form of a urea solution, in particular according to DIN 70070.

When using such systems in the selective catalytic reduction in utility vehicles, a so-called Onboard Diagnosis (OBD) of the function of the SCR catalyst system is legally required. Also, to prevent intervention, it is required that the reducing agent that is used be subjected to continuous quality control in order to avoid injecting, e.g., pure water into the exhaust gas stream.

Arrangements for fill-level measurement with float gauges or by means of a pressure sensor installed in the bottom of a tank are known. When using a pressure sensor in the bottom of a tank, the expensive sealing of the arrangement is disadvantageous. When using a float gauge, it is disadvantageous that the latter can be limited in its freedom of motion because of clogging or aging processes and thus no longer operates reliably.

Another drawback in the known systems is that the latter are not frostproof, since the urea solution that is usually entrained in utility vehicles freezes at −11° C., whereby the density of the aqueous reducing agent solution decreases when freezing, which has the result of a volume increase in a corresponding order of magnitude.

The object of the invention is therefore to provide an arrangement for fill-level measurement of an electrically conductive liquid in a container that has a simple design and is frostproof.

This object is achieved according to the invention by an arrangement for fill-level measurement according to claim 1 as well as a reducing agent container according to claim 11. Advantageous further developments of the invention are indicated in the dependent claims.

In the arrangement, according to the invention, for fill-level measurement of an electrically conductive liquid in a container, in particular for fill-level measurement in a reducing agent tank of an exhaust gas aftertreatment system, whereby a large number of electrodes are arranged some distance apart above one another in the vertical direction, so that the filling level can be derived from a change in the electrical potential difference between the two electrodes that results from the bridging of the distance between two electrodes with a conductive liquid, whereby the electrodes are connected to terminals by strip conductors, it is especially advantageous that the electrodes and the strip conductors are embedded in a flexible carrier medium, and the strip conductors are elastic and crushable.

Since the electrodes and the strip conductors are embedded in a flexible carrier medium and the strip conductors are elastic and crushable, the entire arrangement allows deformations, such as can occur, for example, in a volume change when the aqueous reducing agent solution freezes and its specific volume changes.

In contrast to the previously known solutions, the fill-level measurement is carried out without mechanically movable parts. In this case, the arrangement for fill-level measurement can be arranged directly in the tank. Thus, no sheeting that is critical for the sealing of the container in the bottom of a tank is also necessary.

In a first preferred embodiment, in each case two adjacent electrodes are combined into a pair of electrodes and backplate electrodes. In the arrangement of several such electrode pairs in the vertical direction above one another, a step-by-step detection of the filling level within the container is possible by the respective individual electrode pairs being evaluated. If an electrode pair that consists of electrode and backplate electrode is bridged by the electrically conductive liquid, a change in the electrical potential difference between these two electrodes of the related electrode pair results from the above. In this respect, it is possible to monitor the filling level within the container in discrete steps.

In another preferred embodiment, the electrodes that are arranged above one another in the vertical direction have a common backplate electrode. These individual backplate electrodes can extend over the height of the measuring area of the sensor arrangement or else can be arranged in the lower area of the container, so that this backplate electrode is always wetted by the electrically conductive liquid.

By evaluating which of the electrodes arranged above one another in the vertical direction is wetted, the fill-level height within the container can thus also be determined in this embodiment in discrete steps.

Preferably, the flexible carrier medium is formed by an elastomer. In this case, this can be in particular ethylene-propylene-diene rubber.

By the flexible carrier medium in which the electrodes and the strip conductors are embedded, a bendable plate is thus formed, i.e., a soft plastic plate is formed. Because the flexible carrier medium is bendable, deformations are allowed, so that any stresses and deformations that occur do not result in damage but rather are taken up by the flexible carrier medium, since the strip conductors embedded therein are also crushable and elastic.

The strip conductors, electrons and optionally additional sensor technology are thus arranged on a bendable soft plastic plate or embedded in the latter so that the flexible carrier medium offers at the same time an electrical insulation against the environment and in particular against any corrosive medium.

In an especially preferred embodiment, also at least one sensor for measuring a material property of the liquid as well as elastic and crushable strip conductors that are connected to the sensor are embedded in the carrier medium. By these strip conductors, the sensor can be connected to an analysis unit via corresponding terminals of the strip conductors.

As a result, an especially preferred combination can be achieved by a sensor arrangement being made possible both for fill-level measurement and for quality measurement in order to monitor both an adequate fill-level height and the quality of the reducing agent that is used in a reducing agent tank of an exhaust gas aftertreatment system by the reducing agent that is used being qualitatively monitored by means of the sensor for measuring a material property.

In a preferred embodiment, at least one sensor for measuring the electrical conductivity as well as elastic and crushable strip conductors that are connected to the sensor are embedded in the carrier medium. By the terminals of the strip conductors, the sensor can thus be connected to an analysis unit for further processing of the sensor signals.

In the case of an aqueous urea solution, the electrical conductivity of the liquid is a measure of the quality of the urea solution that is used.

As an alternative or cumulatively, a sensor for measuring the speed of sound in the liquid as well as elastic and crushable strip conductors that are connected to the sensor can also be embedded. By terminals of these strip conductors, the sensor can be connected to an analysis unit for further processing of the sensor signals.

Just like electrical conductivity, the speed of sound also forms a resilient criterion for monitoring the quality of the medium that is used in the reducing agent tank of an exhaust gas aftertreatment system.

The strip conductors are preferably formed by bendable strips that are embedded in zigzag lines or wavy lines or the like in the flexible carrier medium. The paths of the strips within the carrier medium can thus be in particular accordion-shaped, meandering, rectangular, sawtooth-shaped, triangular or the like; this ensures that bends, elongations, and bucklings of the flexible carrier medium can be compensated for without the strip conductors being damaged in this case.

The electrodes and/or sensors for making contact with the liquid are preferably arranged on the front side on the carrier medium, whereby the carrier medium has a self-adhesive layer on the back side.

In this respect, it is possible to glue the carrier medium to an inside wall of the reducing agent tank or container, which makes possible a very simple and reasonably priced assembly.

The inherently flexible component can thus be connected tightly to the inside wall of the storage container in a single production step. In this respect, an especially simple integration of the fill-level and/or quality monitoring in the container, in particular the reducing agent tank of an exhaust gas aftertreatment system, is produced.

Preferably, the electrodes and/or the sensors are connected by the terminals to an analysis unit, which is set up to determine the fill-level height from potential difference changes that occur between electrode pairs and/or a measure of the media quality of the liquid from sensor signals.

In this respect, in the case of the application in motor vehicles, the so-called onboard diagnoses required by law is made possible by an analysis unit being provided, which directly determines the tank fill-level and/or the media quality from the measured values of the arrangement for fill-level measurement and/or media quality monitoring.

In this case, corresponding storage means can be provided to store the continuously or periodically performed measurements or the analysis results from these measurements permanently and in particular in a readable manner to make later review possible.

By the monitoring of the media quality, it is thus ensured, in the case of the monitoring of a reducing agent tank of an exhaust gas aftertreatment system, that simple water is not poured into the reducing agent tank to lower operating costs, for example, since with both the fill-level measurement and in the case that in addition a sensor for detecting the media quality is arranged, intervention is impossible since the arrangement is itself preferably mounted in the reducing agent container.

It is thus especially advantageous in the reducing agent container, according to the invention, of an exhaust gas aftertreatment system of a combustion engine or the like for receiving and storing a reducing agent that the container has an arrangement according to the invention on the inside for fill-level measurement.

In a preferred embodiment of the reducing agent container, an analysis unit is arranged that is connected to the terminals of the arrangement for fill-level measurement and by means of which an analysis of the electrical potential differences applied between the electrodes is carried out to determine the filling level in the container and/or an analysis of the signals of a sensor is carried out to determine the material quality of the reducing agent; in particular an analog-digital conversion of electrodes, voltage and/or sensor signals is performed, and in particular a further processing of data is made available.

The sensor arrangement is preferably connected to the inside wall of a container. In particular, the sensor arrangement can be self-adhesive or be glued with an additive to the inside wall of a container. In this connection, an especially simple assembly is possible.

The use of a reducing agent container according to the invention as well as the arrangement according to the invention for fill-level measurement in the framework of a system for exhaust gas aftertreatment is especially advantageous in internal combustion engines, combustion engines and the like for selective catalytic reduction of nitrogen oxides in exhaust gas by means of an SCR catalyst, whereby both the fill-level height in the reducing agent tank and preferably a material property of the reducing agent that is used, in particular the electrical conductivity and/or the speed of sound of the reducing agent, in particular an aqueous urea solution, are detected and monitored.

The application or use of the arrangement according to the invention for fill-level measurement and the reducing agent container according to the invention is in this case not limited to motor vehicles, in particular utility vehicles, construction vehicles, and the like, but rather can also be used in other combustion systems, garbage incinerators, gas turbines, industrial plants and stationary engines. The application in utility vehicles is an especially preferred application of the invention, however.

One embodiment of an arrangement according to the invention for fill-level measurement is depicted in the figure and is explained in more detail below. Here:

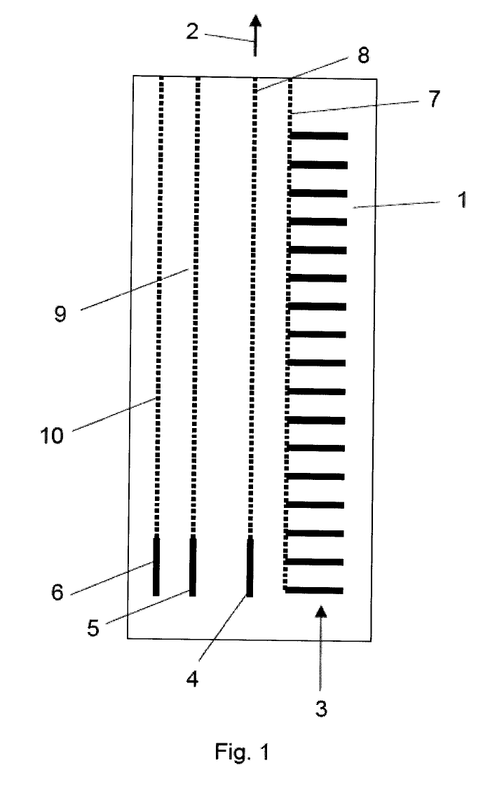

FIG. 1 shows a schematic top view of an arrangement for fill-level measurement of an electrically conductive liquid in a container.

The arrangement for fill-level measurement and quality monitoring of the reducing agent that is used in an exhaust gas aftertreatment system is formed by a flexible carrier medium 1, which forms a bendable plastic plate. This flexible plate 1 consists of an elastomer. The electrodes or sensors that are depicted by solid lines and the insulated strip conductors that are depicted by dotted lines are embedded in plate 1.

In the vertical extension 2, the plate 1 has a large number of electrodes 3 that are arranged some distance apart and that are used in the fill-level measurement. In the series characterized with the reference number 3, a large number of electrodes are arranged some distance apart from one another and above one another in the vertical direction 2. These electrodes 3 in each case have an uninsulated contact surface for making contact with electrically conductive liquid, in particular the reducing agent in the container. The electrode series 3 is a common backplate electrode 4 aligned in the vertical lower area of the flexible plate 1.

Depending on which electrode of the electrode series 3 is wetted within the tank based on the fill-level height, a corresponding potential difference of a special individual electrode of the electrode series 3 is produced relative to the backplate electrode 4, which can be analyzed by a corresponding analysis unit. By strip conductors 7, 8 that are embedded in a crushable and elastic manner in the flexible plate 1, the electrode series 3 are connected by the strip conductor 7 and the backplate electrode 4 by the strip conductor 8 to the corresponding terminal areas, so that the signals can be relayed to a control device or an electronic analysis device, as depicted by the arrow 2. In this case, each individual electrode of the electrode series 3 is brought into contact by a special strip conductor, whereby for reasons of the depiction in FIG. 1, only one strip conductor 7 is depicted.

Also, a sensor for quality measurement is arranged in the lower area of the flexible plate 1 that is viewed in the vertical. This sensor for quality measurement is formed by two electrodes 5, 6 that have a contact surface for making contact with the electrically conductive liquid and by means of which the electrical conductivity of the liquid within the tank is determined. The electrodes 5, 6 of the quality sensor are connected by strip conductors 9, 10, also insulated, to related terminal areas. By the terminal areas of the strip conductors 9, 10, a connection to an electronic analysis device or a control device is possible, by means of which an analysis of the electrical conductivity of the poured medium that is measured with the electrodes 5, 6 is carried out.

The fill-level measurement as well as the quality monitoring of the poured medium is thus carried out without mechanically movable parts. All measuring elements 3, 4 and 5, 6 are integrated and are embedded in a flexible carrier medium 1 in the form of a flexible plastic plate. In this case, for the fill-level measurement, both resistive and capacitive circuit stages can be used. Both measuring processes ultimately aim at producing a voltage change at the input of a microcontroller, which can be provided by means of analog-digital conversion for further processing. The relaying of the measurement data from the plate 1 is carried out by the indicated arrow 2 to a corresponding control device, not shown, of the exhaust gas aftertreatment system. At the upper end of the bendable plate 1, the strip conductors 7, 8, 9, 10 are provided with terminals, not shown, for making contact with an analysis unit.

Also, it is possible to apply the interfaces that are necessary for an ultrasound measurement to the flexible carrier medium 1. Production processes for the plate 1 with all embedded strip conductors 7, 8, 9, and 10 and electrodes 3, 4, and 5, 6 are preferably compression or sputtering.

In turn, in another production step, the inherently flexible component can be connected tightly to the inside wall of the reducing agent tank of an exhaust gas aftertreatment system, for example by gluing to the inside wall of a tank.

1. An arrangement for fill-level measurement of an electrically conductive liquid in a container, in particular for fill-level measurement in a reducing agent tank of an exhaust gas after treatment system, whereby at least two electrodes (3, 4) are arranged a predetermined distance apart above one another in the vertical direction (2), so that the filling level can be derived from a change in the electrical potential difference between the at least two electrodes (3, 4) that results from the bridging of the distance between said electrodes (3, 4) with a conductive liquid, whereby the electrodes (3, 4) are connected to terminals by strip conductors (7, 8), characterized in that the electrodes (3, 4) and the strip conductors (7, 8) are embedded in a flexible carrier medium (1), and the strip conductors (7, 8) are elastic and crushable.

2. An arrangement according to claim 1, wherein in each case adjacent electrodes of said at least two electrodes form a pair of electrodes and backplate electrodes.

3. An arrangement according to claim 2, wherein the electrodes (3) that are arranged above one another in the vertical direction have a common backplate electrode (4).

4. An arrangement according to claim 3 wherein the flexible carrier medium (1) is formed by an elastomer, in particular ethylene-propylene-diene rubber.

5. An arrangement according to claim 3 wherein in the carrier medium (1), at least one sensor (5, 6) for measuring a material property of the liquid as well as elastic and crushable strip conductors (9, 10) that are connected to the sensor (5, 6) can also be embedded, so that the sensors (5, 6) can be connected to an analysis unit by terminals of the strip conductors (9, 10).

6. An arrangement according to claim 3 wherein in the carrier medium (1), at least one sensor (5, 6) for measuring the electrical conductivity of the liquid as well as elastic and crushable strip conductors (9, 10) that are connected to the sensor (5, 6) are embedded, so that the sensor (5, 6) can be connected to an analysis unit by terminals of the strip conductors (9, 10).

7. An arrangement according to claim 3 wherein in the carrier medium (1), at least one sensor for measuring the speed of sound in the liquid as well as elastic and crushable strip conductors that are connected to the sensor are embedded, so that the sensor can be connected to an analysis unit by terminals of the strip conductors.

8. An arrangement according to claim 3 wherein the strip conductors (7, 8, 9, 10) are formed by bendable strips, which are embedded in the flexible carrier medium in zigzag lines or wavy lines.

9. An arrangement according to claim 3 wherein the electrodes (3, 4) and/or sensors (5, 6) for making contact with the liquid are arranged on the front side on the carrier medium (1), and the carrier medium (1) has a self-adhesive layer on the back side.

10. An arrangement according to claim 3 wherein the electrodes (3, 4) and/or sensors (5, 6) are connected by terminals to an analysis unit, which is set up to determine the fill-level height from potential difference changes that occur between electrode pairs and/or a measure of the media quality of the liquid from sensor signals.

11. A reducing agent container of an exhaust gas aftertreatment system of a combustion engine or the like, wherein on the inside, the container has an arrangement for fill-level measurement according to claim 1.

12. A reducing agent container according to claim 11, wherein an analysis unit is arranged that is connected to the terminals of the arrangement for fill-level measurement and by means of which an analysis of the electrical potential differences applied between the electrodes is carried out to determine the filling level in the container and/or an analysis of the signals of a sensor is carried out to determine the material quality of the reducing agent; in particular an analog-digital conversion of electrode and/or sensor signals is performed.

13. A reducing agent container according to claim 11, wherein the sensor arrangement is affixed to the inside wall of a container.
